(19) United States
(12) Patent Application Publication
(10) Pub. No.: US 2014/0149062 A1
(43) Pub. Date: May 29, 2014

(54) SENSOR CALIBRATION

(71) Applicants: MOULISHANKAR CHANDRASEKARAN, Folsom, CA (US); JAMES TRETHEWEY, Hillsboro, OR (US)

(72) Inventors: MOULISHANKAR CHANDRASEKARAN, Folsom, CA (US); JAMES TRETHEWEY, Hillsboro, OR (US)

(21) Appl. No.: 13/687,731

(22) Filed: Nov. 28, 2012

(51) Int. Cl. G01D 18/00

(52) U.S. Cl. CPC G01D 18/00
USPC 702/104

(57) ABSTRACT

A method and system for generating calibrated data are described herein. The method includes detecting a computing device is in a first position and detecting axis data that corresponds to a sensor of the computing device in the first position. The method also includes using the axis data to modify sensor data to produce calibrated data. Furthermore, the method includes sending the calibrated data to an operating system.

### TECHNICAL FIELD

This disclosure relates generally to sensors attached to a computing device, and more specifically, but not exclusively, to sensor calibration.

### BACKGROUND

Modern computing devices continue to incorporate a growing number of components. For example, modern computing devices may include sensors that can provide additional information to the computing device about the surrounding environment. In some examples, the sensors may include a gyrometer, an accelerometer, or a magnetometer. A gyrometer may detect the angular velocity of a computing device. In some examples, an accelerometer may detect the change in velocity of a computing device. A magnetometer may detect the direction the computing device is traveling.

### BRIEF DESCRIPTION OF DRAWINGS

FIG. 1 is a block diagram of an example of a computing system that enables a sensor controller to send calibrated data to an operating system;

FIG. 2 is a process flow diagram for an example method of generating calibrated data;

FIGS. 3A, 3B, 3C, 3D, 3E, and 3F are illustrations of example computing device positions during axis data detection;

FIG. 4 is an example process flow diagram for a method of detecting axis data;

FIG. 5 is a block diagram of an example of a sensor controller that can send calibrated data to an operating system; and

FIG. 6 is a tangible, non-transitory computer-readable medium that can enable the generation of calibrated data.

### DETAILED DESCRIPTION

Modern computing devices can include components installed in the computing devices in a variety of positions. In some examples, certain components may be installed in a computing device to allow for a particular design such as maintaining a certain thickness of the computing device, among others. For example, a computing device may include a sensor that is mounted within the computing device at an angle to accommodate for certain design considerations. However, the sensor may be installed inside the computing device at an angle that is different than the angle which the sensor is designed to operate.

According to embodiments of the subject matter disclosed herein, a computing device can generate calibrated data. Calibrated data can be generated by modifying raw data collected from various components, such as sensors, or USB devices, among others. In some embodiments, the raw data can include sensor data detected from any suitable number of sensors, such as a magnetometer (also referred to herein as a compass), an accelerometer, and a gyrometer (also referred to herein as a gyroscope), among others. In some examples, the raw data can be modified with axis data. The axis data, as referred to herein, can indicate the angle and orientation at which a component is mounted within a computing device. The raw data modified with the axis data can result in calibrated data, which represents raw data that is adjusted based on the angle and orientation at which a component is installed in the computing device.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

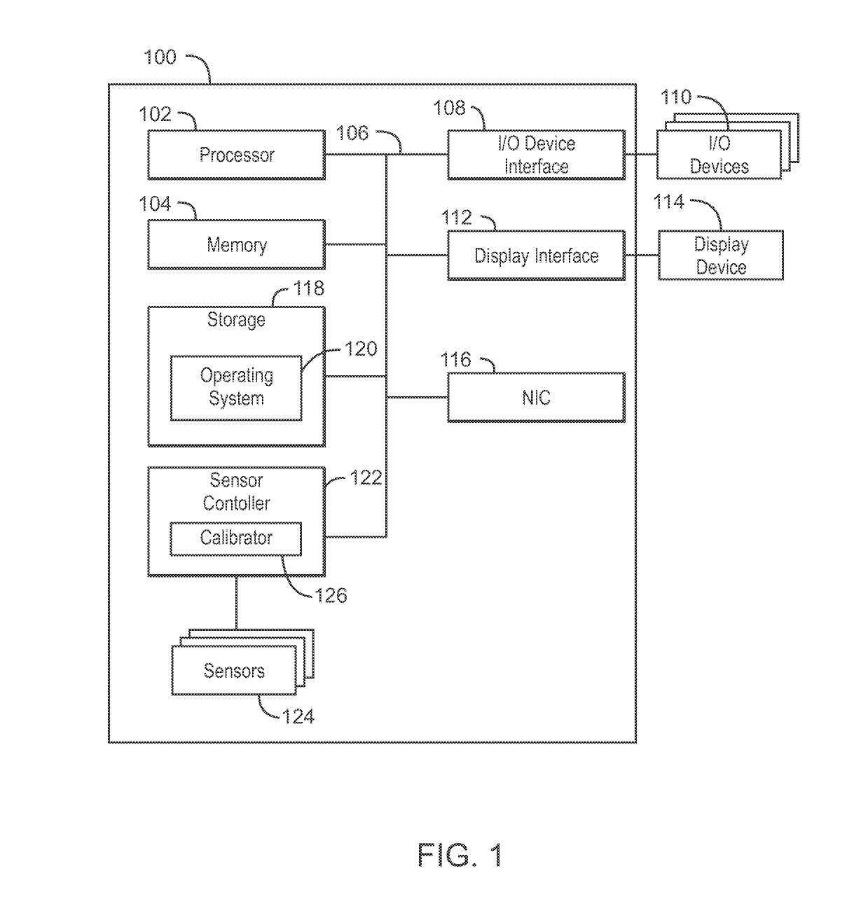

FIG. 1 is a block diagram of an example of a computing system that enables a sensor controller to send calibrated data to an operating system. The computing system 100 may be, for example, a mobile phone, laptop computer, desktop computer, or tablet computer, among others. The computing system 100 may include a processor 102 that is adapted to execute stored instructions, as well as a memory device 104 that stores instructions that are executable by the processor 102. The processor 102 can be a single core processor, a multi-core processor, a computing cluster, or any number of other configurations. The processor 102 may be implemented as Complex Instruction Set Computer (CISC) or Reduced Instruction Set Computer (RISC) processors, x86 Instruction set compatible processors, multi-core, or any other microprocessor or central processing unit (CPU). In some embodiments, the processor 102 includes dual-core processor(s), dual-core mobile processor(s), the like.

The memory device 104 can include random access memory (e.g., SRAM, DRAM, zero capacitor RAM, SONOS, eDRAM, EDO RAM, DDR RAM, RRAM, PRAM, etc.), read only memory (e.g., Mask ROM, PROM, EPROM, EEPROM, etc.), flash memory, or any other suitable memory systems. The memory device 104 can be used to store computer-readable instructions that, when executed by the processor, direct the processor to perform various operations in accordance with embodiments described herein. For example, the instructions that are executed by the processor 102 may be used to implement a method that generates calibrated data.

The processor 102 may be connected through a system interconnect 106 (e.g., PCI, ISA, PCI-Express®, HyperTransport®, NuInterconnect, etc.) to an input/output (I/O) device interface 108 adapted to connect the computing system 100 to one or more I/O devices 110. The I/O devices 110 may include, for example, a keyboard and a pointing device, wherein the pointing device may include a touchpad or a touchscreen, among others. The I/O devices 110 may be built-in components of the computing system 100, or may be devices that are externally connected to the computing system 100.

The processor 102 may also be linked through the system interconnect 106 to a display interface 112 adapted to connect the computing system 100 to a display device 114. The display device 114 may include a display screen that is a built-in component of the computing system 100. The display device 114 may also include a computer monitor, television, or projector, among others, that is externally connected to the computing system 100. The processor 102 may also be linked through the system interconnect 106 to a network interface card (NIC) 116. The NIC 116 may be adapted to connect the computing system 100 through the system interconnect 106 to a network (not depicted). The network may be a wide area network (WAN), local area network (LAN), or the Internet, among others.

The computing device 100 may also include a storage device 118. The storage device 118 may include a physical memory such as a hard drive, an optical drive, a flash drive, an array of drives, or any combinations thereof. The storage device 118 may also include remote storage drives. The storage device 118 may also include an operating system 120. In some embodiments, the storage device 118 may store instructions thereon to receive calibrated data from a controller 122. In some embodiments, the operating system 120 may include one or more drivers. The drivers can enable a hardware component or an application to communicate with the operating system 120. The drivers may also be used to enable a controller 122 to communicate data from sensors 124 to an application via the operating system 120, in accordance with some embodiments. In some embodiments, the drivers are stored in the memory device 104. The memory device 104 may include instructions used to receive calibrated data in a similar manner as described in reference to the operating system 120 above.

The controller 122 may include a calibrator 126. In some embodiments, the calibrator 126 can generate calibrated data and send the calibrated data to the operating system 120. As discussed above, the calibrated data can be generated by modifying raw data from the sensors 124. In some embodiments, the calibrated data modifies raw data from the sensors 124 based on axis data. As discussed above, axis data can indicate the angle and orientation a sensor 124 is mounted within a computing device 100. In some embodiments, the axis data can be determined by placing the computing device 100 in several positions and detecting axis data in each position. In some examples, the axis data may include data based on sensor axes and device axes. For example, a sensor may detect sensor data in relation to a sensor coordinate system that includes sensor axes. The sensor coordinate system may use sensor axes to generate sensor data based on a predetermined orientation and angle in which the sensor is designed to operate in a computing device. The orientation of a sensor can refer to the placement of the sensor in a computing device. For example, a sensor may have a different orientation if the sensor is installed upside down or perpendicular to the predetermined orientation of the sensor. In some embodiments, the axis data may also include sensor data in relation to a device coordinate system. The device coordinate system can indicate the axes which a sensor actually detects sensor data. In some examples, the device coordinate system can represent sensor data based on the actual orientation and angle of the sensor in a computing device. In some embodiments, detecting a dominant axis in each position of a computing device can enable the calibrator 126 to determine the sensor axes and the device axes for a sensor. In some examples, a sensor axis can be mapped to a device axis if the sensor axes are different than the device axes.

In some embodiments, the calibrator 126 may detect three dominant axes that correspond to an X axis, a Y axis, and a Z axis (also referred to herein as a right axis, a forward axis, and an up axis) of a computing device 100. In some examples, the dominant axes can indicate that an axis in the sensor coordinate system is to be mapped to an axis in the device coordinate system. For example, the X-axis in the sensor coordinate system may correspond to the Y-axis in the device coordinate system. Additionally, the axis data may indicate that the sensor data is captured in the device coordinate system at a different angle than the sensor coordinate system. In some embodiments, the calibrator 126 can apply a calibration coefficient to the sensor data. The calibration coefficient can modify the sensor data captured in the device coordinate system. In some embodiments, the sensor data modified by the calibration coefficients can produce calibrated data.

In some embodiments, the sensors 124 may include any suitable number of sensors that collect sensor data. Sensor data can include any information that is detected by a sensor, such as the tilt of a computing device, the direction a computing device is traveling, or the velocity of a computing device, among others. In some embodiments, the sensor data collected by the sensors can be transmitted to the controller 122, which can generate calibrated data with the calibrator 126. The calibrator 126 can also send the calibrated data to an operating system 120.

It is to be understood that the block diagram of FIG. 1 is not intended to indicate that the computing system 100 is to include all of the components shown in FIG. 1. Rather, the computing system 100 can include fewer or additional components not illustrated in FIG. 1 (e.g., additional USB devices, sensors, sensor controllers, etc.). Furthermore, any of the functionalities of the calibrator 126 may be partially, or entirely, implemented in hardware and/or in the processor 102. For example, the functionality may be implemented with an application specific integrated circuit, in an operating system 120, in an application, in a sensor 124, in a processor residing in the sensor controller 122, in a co-processor, or in any other device.

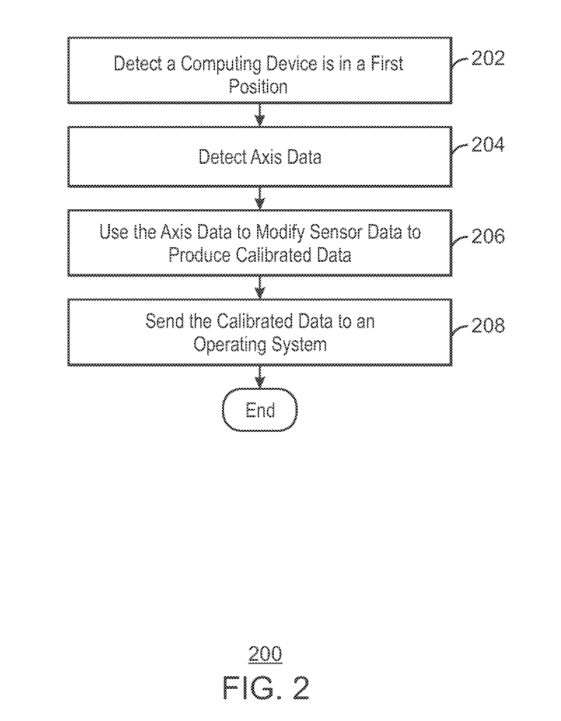

FIG. 2 is a process flow diagram for an example method of generating calibrated data. The method 200 can be implemented with a computing device, such as the computing system 100 of FIG. 1.

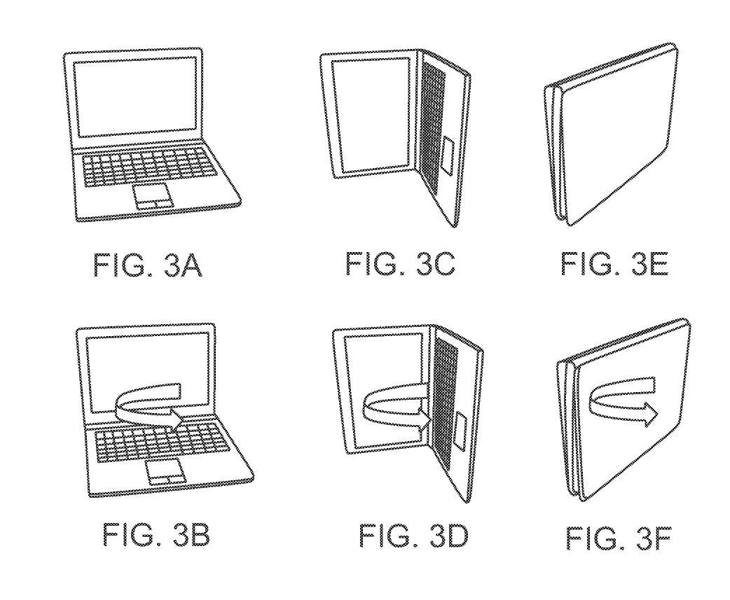

At block 202, the calibrator 126 can detect that a computing device is in a first position. In some embodiments, the first position can include any suitable position of the computing device such as a flat position, a left side position, a front side position, or various rotating positions, among others. Each position may correspond to a particular side of the computing device facing a different direction in relation to a reference plane or the angle between a particular side of the computing device and a reference plane. The reference plane may refer to a horizontal plane, such as a table-top surface, among others. The positions are discussed below in greater detail in relation to FIG. 3.

At block 204, the calibrator can detect axis data. The axis data can represent information related to any suitable axis in a Cartesian coordinate system of any suitable number of dimensions. In some embodiments, the axis data can correspond to a particular sensor. For example, the axis data can indicate the angle of a sensor in relation to a reference plane. In some embodiments, the axis data can also indicate the orientation of a sensor. For example, the axis data can indicate if a sensor is mounted at a particular angle or orientation in relation to the keyboard of a computing device, a display screen of a computing device, or any other component of a computing device, among others.

At block 206, the calibrator 126 can use the axis data to modify sensor data to produce calibrated data. In some embodiments, a sensor may detect sensor data in relation to a predetermined set of axes. For example, a sensor may detect sensor data based on an X-axis, Y-axis, and Z-axis, which correspond to the sensor being located parallel to the base of a computing device. In some examples, the axis data may indicate that the sensor is actually located at an angle that is not parallel with the base of a computing device. In some embodiments, the axis data can be used to modify the sensor data to produce calibrated data. The calibrated data can represent the sensor data modified based on the angle and orientation of the sensor in a computing device. In this way, the calibrated data can be represented in coordinates or angles that are relative to the electronic device housing the sensor, whereas the raw data represents coordinates or angles that are relative to the sensor itself. For example, the calibrated data may indicate that a laptop computer is level even though the sensor may be oriented vertically or at any other angle within the laptop.

At block 208, the calibrator 126 can send the calibrated data to an application. The application can then use the calibrated data rather than sensor data for operations and calculations. In some embodiments, the application can use the calibrated data without determining the angle at which the sensor is installed in the computing device. For example, a sensor may generate raw sensor data based on the angle at which the sensor is installed in relation to a component of a computing device. In some embodiments, an application may not determine if the sensor is actually installed at the angle at which the sensor is designed to operate. In some embodiments, the calibrator 126 may alternatively send the calibrated data to a hardware device, or an operating system. The process ends at block 210.

The process flow diagram of FIG. 2 is not intended to indicate that the steps of the method 200 are to be executed in any particular order, or that all of the steps of the method 200 are to be included in every case. Further, any number of additional steps may be included within the method 200, depending on the specific application.

FIGS. 3A, 3B, 3C, 3D, 3E, and 3F are illustrations of example computing device positions during axis data detection. The flat position (illustrated in FIG. 3A) may represent placing a laptop with the keyboard parallel to a reference plane, such as a surface, or placing a tablet with the display screen parallel to a reference plane, among others. In some embodiments, the calibrator 126 can detect axis data when the computing device is in the flat position. For example, the calibrator 126 may detect a dominant axis in the flat position. As discussed above, the dominant axis may correspond to an axis in which a sensor, such as a gyrometer or accelerometer, among others, detects a value that is greater than the values detected for additional axes. For example, a gyrometer may detect a greater value along one particular axis for a computing device in the flat position. In some embodiments, the dominant axis can be used to determine the orientation of a sensor in a computing device.

In some embodiments, the calibrator 126 can also detect axis data as the computing device is rotated at approximately the same velocity in the flat position (illustrated in FIG. 3B). The axis data may be used to determine calibrated data for any suitable number of sensors such as the gyrometer, among others. As discussed above, the gyrometer can detect the angular velocity of the computing device. In some embodiments, the calibrator 126 may detect that the computing device has not been rotated at approximately the same velocity. In some examples, the calibrator 126 may attempt to repeat gathering the axis data as the computing device is rotated.

In some embodiments, the left side position (illustrated in FIG. 3C) and the front side position (illustrated in FIG. 3E) may also be used to detect axis data used to calibrate any suitable number of sensors. For example, the left side position may include placing the computing device perpendicular to a reference plane, in which the left side of the computing device is closest to the reference plane. The calibrator 126 may detect a second dominant axis in the left side position. In some embodiments, the calibrator 126 can also detect axis data by rotating the computing device at approximately the same velocity while the computing device is in the left side position (illustrated in FIG. 3D).

In some embodiments, the front side position corresponds to placing the computing device perpendicular to the reference plane, with the front of the computing device closest to the reference plane. The calibrator 126 may detect a third dominant axis in the front side position. In some embodiments, rotational axis data may also be detected by the calibrator 126 as the computing device is rotated while the computing device is in the front side position (illustrated in FIG. 3F). In some examples, the calibrator 126 can use the dominant axes as device axes and the calibrator 126 can map the dominant axes to the sensor axes. For example, the calibrator 126 may use the dominant axes to detect that a sensor is sending data along an axis in the device coordinate system that is different than the corresponding axis in the sensor coordinate system. The calibrator 126 can then map the sensor data related to a particular axis in the device coordinate system to the corresponding axis in the sensor coordinate system. As discussed above, if the sensor is installed at an orientation or angle that is different than the orientation at which a sensor is designed to operate, the sensor data in the device coordinate system may differ from sensor data in the sensor coordinate system.

The illustrations in FIG. 3 are not intended to depict all of the positions that can be used to generate calibrated data. Rather, any suitable number of positions may be used to generate calibrated data. For example, the calibrator 126 may generate calibrated data based on axis data detected in the flat position and the left side position without detecting axis data in the front side position.

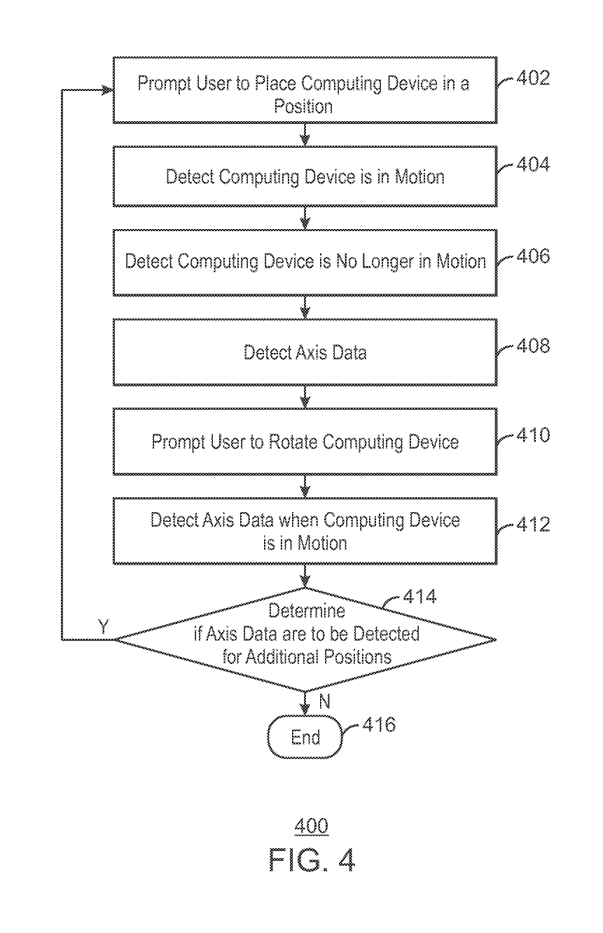

FIG. 4 is an example process flow diagram for a method of detecting axis data. The method 400 can be implemented with any computing device, such as the computing system 100 of FIG. 1.

At block 402, the calibrator 126 may prompt a user to place the computing device in a position. In some embodiments, the position may correspond to a flat position, a left side position, or a front side position, among others. In some examples, the calibrator 126 can send information to a calibration application that displays an image of the computing device in the position. In some examples, the calibrator 126 can also generate feedback, such as audible messages, tones, or haptic vibrations, which may be used instead of or in addition to image display. Some forms of feedback, such as audible messages, tones, or haptic vibrations, can be helpful when the display device of a computing system is difficult to read such as in FIGS. 3E and 3F.

At block 404, the calibrator 126 detects the computing device is in motion. In some embodiments, the calibrator 126 can detect that a user is placing the computing device in the prompted position by determining the computing device is in motion. In one embodiment, the calibrator 126 may also display a verification box, which can detect user input indicating that the computing device is in the prompted position.

At block 406, the calibrator 126 can determine that the computing device is no longer in motion. The calibrator can then detect axis data for the prompted position at block 408. In some embodiments, the calibrator 126 can also detect anomalous data along with the axis data. In some examples, anomalous data can include data detected by the computing device when the computing device is at a different angle than the prompted position or the sensor in the computing device may remain in motion or vibrate, among others. In some embodiments, the axis data can be adjusted to account for the anomalous data. The adjusted axis data can correspond to an X axis, a Y axis, or a Z axis, among others. In some embodiments, a dominant axis may be identified as the axis which has a gravitational value that is greater than the gravitational value of additional axes. The gravitational value can indicate the direction of an axis in the device coordinate system. For example, a sensor, such as a gyrometer, may detect a dominant axis that indicates a sensor is installed at a particular orientation within the computing device.

At block 410, the calibrator 126 can prompt a user to rotate the computing device at an approximately constant velocity. At block 412, the calibrator 126 can detect axis data for the computing device with a gyrometer as the computing device is rotated. In some embodiments, an angular velocity about a dominant axis may be greater than the angular velocity values of additional axes. The detected axis data can be used to indicate the orientation at which the sensor is mounted within the computing device.

At block 414, the calibrator 126 determines if there is additional axis data to be collected for additional positions. If the calibrator 126 is not to collect axis data for additional positions, the process flow ends at block 416. If the calibrator is to collect axis data for additional positions, the process flow returns to block 402.

The process flow diagram of FIG. 4 is not intended to indicate that the steps of the method 400 are to be executed in any particular order, or that all of the steps of the method 400 are to be included in every case. Further, any number of additional steps may be included within the method 400, depending on the specific application. For example, the calibrator 126 may generate an error if data for the same axis is identified after prompting a user to place the computing device in multiple positions. The error can represent an event in which duplicate axis data is detected for a computing device.

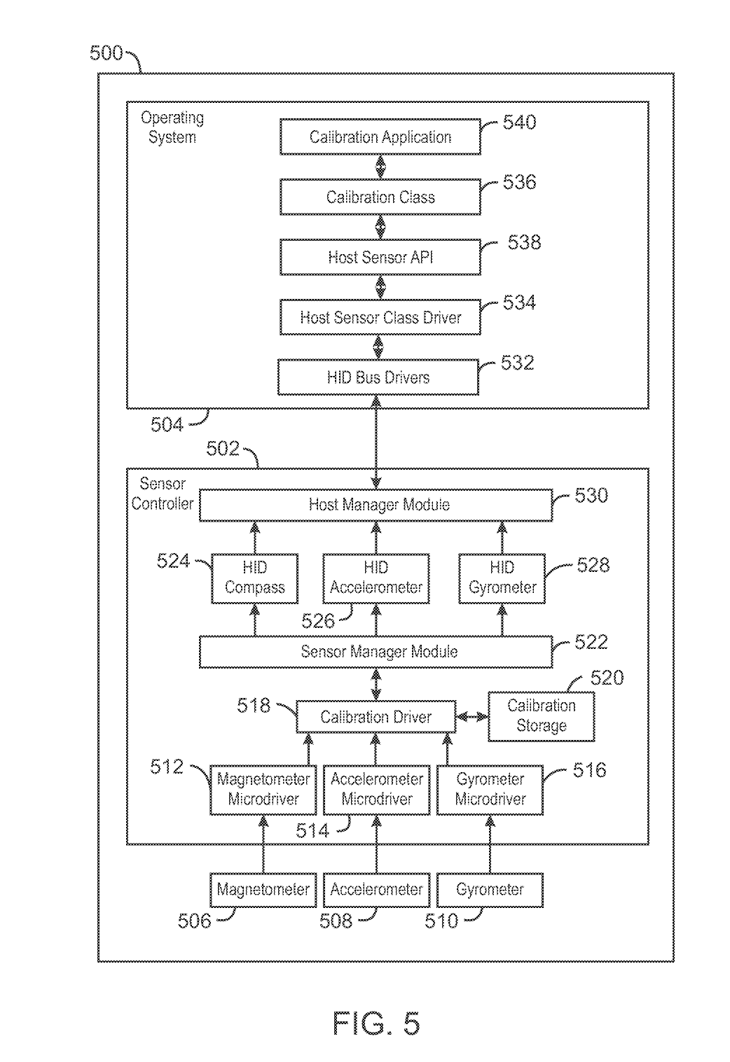

FIG. 5 is a block diagram of an example of a sensor controller that can send calibrated data to an operating system. In some embodiments, a computing device 500 includes the sensor controller 502, an operating system 504, and various sensors such as a magnetometer 506, an accelerometer 508, and a gyrometer 510, among others. The magnetometer 506 can detect data related to the strength or direction of magnetic fields. The accelerometer 508 can detect a change in velocity of a computing device. The gyrometer 510 can detect a change in angular velocity of the computing device.

In some embodiments, the sensor controller 502 can include any suitable number of micro-drivers that can communicate with any suitable number of sensors. For example, the sensor controller 502 may include a magnetometer micro-driver 512, an accelerometer micro-driver 514, and a gyrometer micro-driver 516. The magnetometer micro-driver 512, accelerometer micro-driver 514, and gyrometer micro-driver 516 may include firmware that can enable communication between the sensors and a calibration driver 518. For example, the magnetometer micro-driver 512 may include firmware that can detect data from a particular magnetometer sensor 506 and forward the data from the magnetometer sensor 506 to the calibration driver 518. In some embodiments, the accelerometer micro-driver 514 may include firmware that can detect data from a particular accelerometer 508 and forward the data from the accelerometer 306 to the calibration driver 518. In some embodiments, the gyrometer micro-driver 516 may include firmware that can detect data from a particular gyrometer 510 and forward the data from the gyrometer 510 to the calibration driver 518. In some embodiments, multiple separate calibration drivers may be used, wherein a separate calibration driver corresponds to each of the micro-drivers 512, 514, 516, instead of a single calibration driver 518 corresponding to the micro-drivers 512, 514, and 516.

In some embodiments, the calibration driver 518 can generate calibration coefficients to apply to sensor data from the sensors 506, 508, and 510. For example, the calibration driver 518 may determine that sensor data from a gyrometer 510 is to be adjusted to account for the degree at which the sensor is installed in the computing device. In some embodiments, the calibration coefficients can also indicate the orientation of a sensor based on axis data detected as the computing device is placed in various positions. In some examples, the calibration coefficients can indicate mapping certain axes in the device coordinate system to certain axes in the sensor coordinate system. For example, the dominant axis of the flat position can be mapped to the up axis, which is perpendicular to the reference plane. In some embodiments, the dominant axis of the left side position can be mapped to the right axis, which is parallel to the surface plane. Additionally, the dominant axis of the front side position can be mapped to the forward axis, which is perpendicular to the left side position.

In some embodiments, the axis data and the calibration coefficients can be stored in calibration storage 520. The calibration storage 520 enables the calibration coefficients to be applied to subsequent sensor data without re-calibrating the sensors 506, 508, and 510, which can reduce the frequency of re-calibration of the sensors 506, 508, and 510. In some embodiments, the calibration coefficients can be recalculated if the calibrated data is not accurate. For example, a sensor may change positions in a computing device, which may result in different sensor data.

In some embodiments, the calibrated data can be used to calculate various environmental properties of the computing device. For example, compass data can be generated by mapping the calibrated data from the magnetometer for three axes into calibrated data for two axes. For example, the two axes representing the compass data may be calculated with Equation 1 and Equation 2:

X′=X cos f+Y sin q sin f−Z cos q sin f Equation(1)

Y′=Y cos q+Z sin q Equation(2)

In Equation 1 and Equation 2, the values of X, Y, and Z can correspond to the calibrated data for the up axis, right axis, and forward axis. In some embodiments, the value of “f” can be the pitch detected by the accelerometer and the value of “q” can be the roll angle detected by the accelerometer. The compass heading can be generated with Equation 3:

Heading=arctan(Y′/X′) Equation(3)

In some examples, the heading of Equation 3 can indicate the direction in which a computing device is traveling or a direction in which a computing device is pointed.

In some embodiments, the sensor manager module 522 may analyze data gathered by one or more of the sensors 506, 508, and 510. For example, the sensor manager module 522 may determine position data or angular velocity data, among others, for a computing device based on data received from the calibration driver 518.

The sensor controller 502 may also include one or more HID drivers 524, 526, and 528. In some embodiments, the HID drivers may include a HID compass 524, a HID accelerometer 526, and a HID gyrometer 528, among others. The HID drivers 524, 526, and 528 may be configured to format the data received by the sensor manager module 522. For example, the sensor controller 502 may format data received from the calibration driver 518 related to one or more of the sensors 506, 508, and 510 by packaging the calibrated data to enable the operating system 504 to detect calibrated data from individual sensors transmitted through a single system interconnect, such as a bus.

The sensor controller 502 may also include a host manager module 530 that can aggregate data received from the HID compass 524, the HID accelerometer 526, and the HID gyrometer 528. For example, the host manager module 530 may aggregate data, such as position data, among others, detected by the sensors 506, 508, and 510 and modified by the calibration driver 518. The host manager module 530 may also send the aggregated data to the operating system 504. In some embodiments, the host manager module 530 aggregates the formatted HID and non-vendor specific data to enable the sensor controller 502 to provide the formatted data to the operating system 504 via a single channel. By providing the formatted position data to the operating system 504 via a single channel, such as a USB bus, individual communication interfaces from each of the one or more sensors 506, 508, and 510 can be eliminated.

In some embodiments, the operating system 504 may include HID bus driver 532 that receives the aggregated HID sensor data based on the calibrated data from the calibration driver 518. The HID bus driver 532 can forward the aggregated HID sensor data to a Host sensor class driver 534, which can forward the aggregated HID sensor data to calibration class 536 through a Host sensor API 538. In some embodiments, the calibration class 536 can send the calibrated data to a calibration application 540.

It is to be understood that the block diagram of FIG. 5 is not intended to indicate that the computing system 500 is to include all of the components shown in FIG. 5. Rather, the computing system 500 can include fewer or additional components not illustrated in FIG. 5 (e.g., additional sensors, additional drivers, additional sensor controllers, etc.). Furthermore, the functionality of the calibration driver 518 may reside in the calibration class 536 or the calibration application 540, among others. Additionally, the calibration storage 520 can be volatile memory or non-volatile memory, among others.

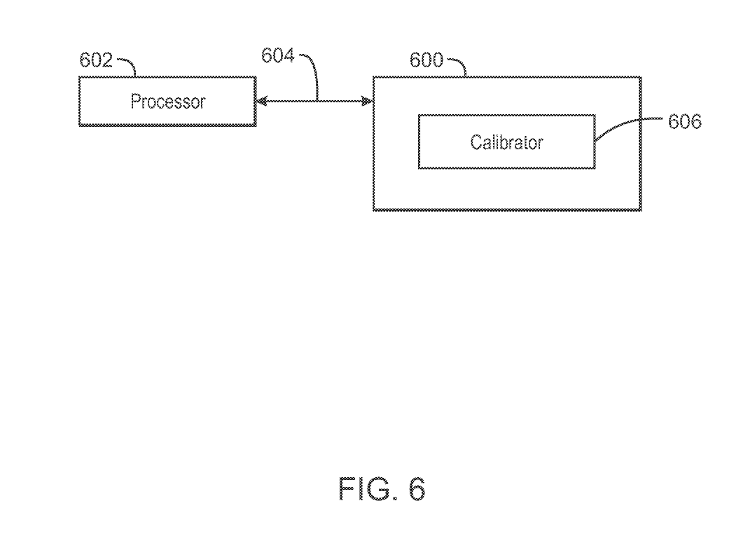

FIG. 6 is a tangible, non-transitory, computer-readable medium that can enable the generation of calibrated data. The tangible, non-transitory, computer-readable medium 600 may be accessed by a processor 602 over a computer interconnect 604. Furthermore, the tangible, non-transitory, computer-readable medium 600 may include code to direct the processor 602 to perform the steps of the current method.

The various software components discussed herein may be stored on the tangible, non-transitory, computer-readable medium 600, as indicated in FIG. 6. For example, a calibrator 606 may be adapted to direct the processor 602 to generate calibrated data. It is to be understood that any number of additional software components not shown in FIG. 6 may be included within the tangible, non-transitory, computer-readable medium 600, depending on the specific application.

### Example 1

A method for generating calibrated data is described herein. The method includes detecting a computing device is in a first position and detecting sensor data a first position. The method also includes detecting axis data that corresponds to a sensor of the computing device in the first position. Furthermore, the method includes using the axis data to modify sensor data to produce calibrated data. The method also includes sending the calibrated data to an operating system.

In some embodiments, the method also includes providing feedback, wherein the feedback comprises one of visual feedback, audible feedback, and haptic feedback. In some examples, the method may provide audible feedback or haptic feedback when the computing device is in a position that obscures the display screen such as the front side position. Additionally, the method can include detecting the computing device is in a second position, detecting the computing device is in a third position, and detecting axis data corresponding to the sensor in the second position and the sensor in the third position. In some embodiments, the axis data from the first position, second position, and third position, can be used to determine the orientation and angle of the sensor in the computing device.

### Example 2

A system for generating calibrated data is described herein. The system includes a sensor to detect sensor data, a processor to execute computer-readable instructions, and a storage device to store computer-readable instructions. The computer-readable instructions can direct a processor to detect a computing device is in a first position detect axis data that corresponds to the sensor of the computing device in the first position. The computer-readable instructions can also direct a processor to use the axis data to modify sensor data to produce calibrated data. Furthermore, the computer-readable instructions can cause the processor to send the calibrated data to an operating system.

In some embodiments, the computer-readable instructions can direct the processor to detect data for at least two axes from the sensor data, determine a dominant axis from the axis data, and map one of the at least two axes from the sensor data to the dominant axis. In some embodiments, the sensor data can be detected by a sensor comprising one of a magnetometer, an accelerometer, and a gyrometer. In some embodiments, the computer-readable instructions can also direct the processor to send the calibrated data from the operating system to an application.

### Example 3

At least one non-transitory machine readable medium comprising a plurality of instructions that generate calibrated data is described herein. In response to being executed on a computing device, the plurality of instructions can cause the computing device to detect a computing device is in a first position, and detect axis data that corresponds to a sensor of the computing device in the first position. The plurality of instructions can also cause the computing device to use the axis data to modify sensor data to produce calibrated data and send the calibrated data to an operating system.

In some embodiments, the axis data indicates an orientation of the sensor and an angle of the sensor in the computing device. In some embodiments, the calibrated data represents sensor data modified based on the axis data. In some embodiments, the axis data is stored in a non-volatile memory to reduce the frequency of re-calibration.

Some embodiments may be implemented in one or a combination of hardware, firmware, and software. Some embodiments may also be implemented as instructions stored on the tangible non-transitory machine-readable medium, which may be read and executed by a computing platform to perform the operations described. In addition, a machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A method for generating calibrated data comprising:
detecting a computing device is in a first position;
detecting sensor data in a first position;
detecting axis data that corresponds to a sensor of the computing device in the first position;
using the axis data to modify sensor data to produce calibrated data; and
sending the calibrated data to an operating system.

2. The method of claim 1 comprising:
detecting the computing device is in a second position;
detecting the computing device is in a third position; and
detecting axis data corresponding to the sensor in the second position and the sensor in the third position.

3. The method of claim 1 wherein detecting the computing device is in the first position comprises providing feedback, wherein the feedback comprises one of visual feedback, audible feedback, and haptic feedback.

4. The method of claim 1 wherein the sensor data comprises data detected from one of a magnetometer, an accelerometer, and a gyrometer.

5. The method of claim 1 wherein using the axis data to modify sensor data to produce calibrated data comprises:
detecting data for at least two axes from the sensor data;
determining a dominant axis from the axis data; and
mapping one of the at least two axes from the sensor data to the dominant axis.

6. The method of claim 1 comprising sending the calibrated data from the operating system to an application.

7. The method of claim 6 wherein the application is a driver residing in a hardware device.

8. The method of claim 1 wherein the calibrated data represents sensor data modified based on the position of a sensor in the computing device.

9. The method of claim 1 wherein the axis data indicates an orientation of the sensor and an angle of the sensor in the computing device.

10. The method of claim 9, wherein the axis data is stored a non-volatile memory to reduce the frequency of re-calibration.

11. A system for generating calibrated data comprising:
a processor to:
detect a computing device is in a first position;
detect axis data that corresponds to a sensor of the computing device in the first position;
use the axis data to modify sensor data to produce calibrated data; and
send the calibrated data to an operating system.

12. The system of claim 11, wherein the processor is to:
detect the computing device is in a second position;
detect the computing device is in a third position; and
detect axis data corresponding to the sensor in the second position and the sensor in the third position.

13. The system of claim 11, wherein the processor is to provide one of visual feedback, audible feedback, and haptic feedback.

14. The system of claim 11 wherein the sensor comprises one of a magnetometer, an accelerometer, and a gyrometer.

15. The system of claim 11 wherein the processor is to:
detect data for at least two axes from the sensor data;
determine a dominant axis from the axis data; and
map one of the at least two axes from the sensor data to the dominant axis.

16. The system of claim 11, wherein the processor is to send the calibrated′ data from the operating system to an application.

17. The system of claim 16 wherein the application is a driver residing in a hardware device.

18. The system of claim 11 wherein the calibrated data represents sensor data modified based on the position of a sensor in the computing device.

19. The system of claim 11 wherein the axis data indicates an orientation of the sensor and an angle of the sensor in the computing device.

20. The system of claim 11 wherein the axis data is stored in a non-volatile memory to reduce the frequency of re-calibration.

21. The system of claim 11, wherein the processor is a sensor controller.

22. The system of claim 11, wherein the sensor detects the sensor data.

23. At least one non-transitory machine readable medium comprising a plurality of instructions that, in response to being executed on a computing device, cause the computing device to:
detect a computing device is in a first position;
detect axis data that corresponds to a sensor of the computing device in the first position;
use the axis data to modify sensor data to produce calibrated data; and
send the calibrated data to an operating system.

24. The at least one non-transitory machine readable medium of claim 23, wherein the plurality of instructions cause the computing device to:
detect the computing device is in a second position;
detect the computing device is in a third position; and
detect axis data corresponding to the sensor in the second position and the sensor in the third position.

25. The at least one non-transitory machine readable medium of claim 23, wherein the plurality of instructions cause the computing device to provide one of visual feedback, audible feedback and haptic feedback.

26. The at least one non-transitory machine readable medium of claim 23, wherein the sensor comprises one of a magnetometer, an accelerometer, and a gyrometer.

27. The at least one non-transitory machine readable medium of claim 23, wherein the plurality of instructions cause the computing device to:
detect data for at least two axes from the sensor data;
determine a dominant axis from the axis data; and
map one of the at least two axes from the sensor data to the dominant axis.

28. The at least one non-transitory machine readable medium of claim 23, wherein the plurality of instructions cause the computing device to send the calibrated data from the operating system to an application.

29. The at least one non-transitory machine readable medium of claim 28 wherein the application is a driver residing in a hardware device.

30. The at least one non-transitory machine readable medium of claim 23, wherein the calibrated data represents sensor data modified based on the position of a sensor in the computing device.

31. The at least one non-transitory machine readable medium of claim 23, wherein the axis data indicates an orientation of the sensor and an angle of the sensor in the computing device.

32. The at least one non-transitory machine readable medium of claim 23, wherein the axis data is stored in a non-volatile memory to reduce the frequency of re-calibration.
